(19) United States
(12) Patent Application Publication
(10) Pub. No.: US 2008/0063836 A1
(43) Pub. Date: Mar. 13, 2008

(54) METALLIZED PLASTIC COMPONENT WITH A DISPLAY AREA AND METHOD FOR MANUFACTURE

(76) Inventor: Frank Lochner, Wollbach (DE)

Correspondence Address: MG-IP Law, PLLC, P.O. BOX 1364, FAIRFAX, VA, 22038-1364, US

(21) Appl. No.: 11/838,125

(22) Filed: Aug. 13, 2007

Related U.S. Application Data
(63) Continuation of application No. PCT/EP06/01279, filed on Feb. 13, 2006.

(30) Foreign Application Priority Data
Feb. 12, 2005 (DE) 10 2005 006 459

(51) Int. Cl. B32B 3/10; C25D 5/34

(52) U.S. Cl. 428/138; 205/205

(57) ABSTRACT

A metallized plastics component is provided with a first adhesion-promoting layer and a second metallic cover layer. The invention also relates to a method for producing a metallized plastics component, in which the plastics component is provided first with an adhesion-promoting layer and then with a cover layer.

This nonprovisional application is a continuation of International Application No. PCT/EP2006/001279, which was filed on Feb. 13, 2006, and which claims priority to German Patent Application No. DE 102005006459, which was filed in Germany on Feb. 12, 2005, and which are both herein incorporated by reference.

### BACKGROUND OF THE INVENTION

1. Field of the Invention

The present invention relates to a metallized plastic component having a first coupling layer and a second metallic covering layer, and a method for the manufacture of a metallized plastic component, in which, first a coupling layer and then a covering layer are applied to the plastic component.

2. Description of the Background Art

A preferred field of application of the invention is in the field of motor vehicles and therein in control elements which are backlit for the most part. Translucent plastics are employed preferably for backlighting in this case; these offer the possibility by means of an illuminant to light the pushbuttons or the control element from its back and to transilluminate a symbol incorporated into the control element or button. A preferred material, employed in the automotive industry, in this case is polycarbonate (PC). This plastic offers the best properties in regard to processing and transillumination.

A trend becoming accepted in control elements in motor vehicles is to provide the control elements with a metallic-like appearance. In this regard, the components are injection molded of plastic and provided with a metallic coating using highly diverse techniques. Metallic surfaces, which have highly glossy chrome-like appearance or the appearance of aluminum or ruthenium (Ru) or a similar surface, according to the current state of the art are applied by an electroplating or PVD (physical vapor deposition) method.

In electroplating, metallization is typically carried out after the process steps of palladium seeding, reductions, chemical metallization, for example, with nickel or copper, and electrolytic reinforcement, for example, with chromium. In PVD methods, the metallization occurs by means of a physical deposition from the gas phase, for example, evaporation coating.

The Unexamined German Patent Application DE 100 04 555 A1 discloses a layer system for the decorative coating of electroplatable workpieces, in which first a electrodeposited layer is deposited on the workpiece and then a layer created by means of a PVD method. Plastics in particular are cited here as materials. The layer system applied to the workpiece in this case has the priority task of providing a layer system, which fulfills the high requirements for corrosion resistance, at the same time has a high stripping resistance, and moreover offers a multitude of decorative color schemes. The advantageous possibilities for this layer system on plastics or the plastics that may preferably be used are not indicated in this publication.

The use of a PVD method in regard to plastics for creating metal layers on workpieces is described in detail in the Unexamined German Patent Application DE 103 37 456 A1. Reference is made herewith to the entire content disclosed in this publication, and which is incorporated by reference. Thus, this method offers the possibility of a direct metallization of the surface of the material or component, whereby the metal coating has one or more identical or different metal layers lying one on top of another. Materials or components with low surface energies can also be coated by the technique described in the method. In this case, the surface energies of the materials or components are activated by plasma, as a result of which very good adherence on polymers is created. During plasma activation, a gas or gas mixture is subjected to an electrical gas discharge in vacuum. In so doing, electrons, ions, radicals, and neutral particles are generated, which impact the surface of the material or component. As a result, contaminations can be removed and the surface can be roughened and chemically modified. This is followed by direct metallization, in which in a described exemplary embodiment a chromium and aluminum layer is produced, which has a total thickness of 330 nm.

German patent publication DE 198 51 579 A1 also describes a method for the metallization of plastics and the metallized plastics produced therewith. In this case, the activation of the plastics occurs with the aid of a high-voltage gas discharge at a pressure of 0.1 bar to 1.5 bar. After the application of the surface layer, a metallic coating is applied to the workpiece using any familiar metallization method. The currentless and/or electrolytic metallization is described here as a familiar wet-chemical metallization method.

### SUMMARY OF THE INVENTION

It is therefore an object of the present invention to provide a component and a method in which and with which adherent layers are produced on plastics and in which and with which display areas, such as, for example, symbols, can be produced in the metallic coated surfaces. In addition, the object of the invention is to develop components and methods for manufacture, which can be carried out or produced more cost effectively and with reduced effort.

The object of the invention is achieved in reference to the plastic component to the effect that a display area, particularly a symbol, is introduced in the coupling layer by a laser and the covering layer is applied only in the area of the coupling layer. The embodiment of the metallized plastic component according to the invention now makes it possible to provide the plastic component with a coupling metallic covering layer only in areas. By removal of the coupling layer, the covering layer can adhere to the plastic component only in the area in which the coupling layer still remains on the plastic component. It is thereby possible to introduce symbols, characters, numbers, pictograms, alphanumeric characters, or other pictures in metallic covering layers. These lasered free areas are then used with backlighting of the plastic component as light-transparent areas and therefore as display areas, which, for example, in the motor vehicle identify the operation or function of the control element or button.

In an embodiment, a preferred method for the application of the coupling layer is the PVD method. Any metallic material can be applied to the blank as a plastic component by means of the PVD method also described in the prior art (DE 103 37 456 A1). Preferably, the elements, copper and nickel, or a combination of copper and nickel are applied as the adhesive layer to the plastic component. Accordingly, the coupling layer can be applied in a thickness of about 200 nm to 500 nm. Preferably, however, a thickness of about 300 nm, which corresponds approximately to the thickness of 200 atomic layers, is applied to the plastic component. The applied layer can be, for example, a molybdenum (Mo), chromium (Cr), and aluminum (Al) layer. Solely due to the very small thickness of the coupling layer, it is hereby possible for the laser, without being reflected directly, to remove the adhesive layer in areas. Thus, the energy input by means of the laser into the coupling layer is so great that the coupling layer can be removed.

After the areawise removal of the coupling layer, another metal layer is deposited on the plastic component as a covering layer by means of an electroplating method. This results in an additional advantage, which emphasizes the cost-effectiveness of this component and substantially reduces the manufacturing times. Due to the application of the metallic adhesive layer, the chemical process step of palladium seeding can be omitted, because a metallic adhesive layer already exists on the plastic component and thereby the electrolytic metallization can be started immediately. It is advantageous furthermore in this case that any electroplatable and non-electroplatable plastics can be provided with an electrodeposited covering layer, because the electrodeposited covering layer settles on the plastic component only in the areas provided with the adhesive layer. No covering layer material will adhere in the exposed display area. The metallic covering layer is deposited on the plastic component with a thickness of 20 μm to 100 μm; a preferred thickness here is a thickness of 30 μm to 60 μm.

The plastic component is preferably made of a translucent basic material. Polycarbonate (PC), acrylonitrile-butadiene-styrene (ABS), polyamide (PA), or polymethyl methacrylate (PMMA) are examples here, polycarbonate being employed more preferably. The enumerations of these materials are not limiting; rather, all translucent plastics are included in which backlighting is possible or conceivable. If, for example, a polycarbonate is used and the plastic component is a backlit control element for a motor vehicle, then, the plastic component is made in the display area with a thickness of 0.6 mm.

From the process-related standpoint, the object of the invention is achieved in that before the application of the covering layer, the coupling layer is removed in areas and the covering layer is applied only in the area of the remaining coupling layer. A process step during the electroplating can be omitted as a result of the claimed combination of features in the claims which describes a coupling layer with a metal layer deposited by electroplating thereupon. Thus, particularly the seeding of electroplatable plastics is not necessary, because a metallic coupling layer is already present on the plastic component. This offers the advantage of a shortened electroplating process. The use of the laser makes it possible to depict very precise symbols or pictures on the plastic component.

As already described, neither the PVD method nor the electrolytic metallization method is limited to a special metallic material but depending on customer requirements and design variants, any combinations and color schemes or visual appearance can be created. In addition, it is conceivable to apply a coating layer to the electroplated layer. The electroplated metal layer in fact provides a sufficient adhesiveness and stability, but in regard to special design variants of, for example, control elements, it is possible to apply a coating layer to the electroplated layer in colored or uncolored form.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is partial side view of plastic component according to an embodiment of the present invention;

FIG. 2 is partial side view of plastic component according to another embodiment of the present invention

FIG. 3 is partial side view of plastic component according to yet another embodiment of the present invention.

### DETAILED DESCRIPTION

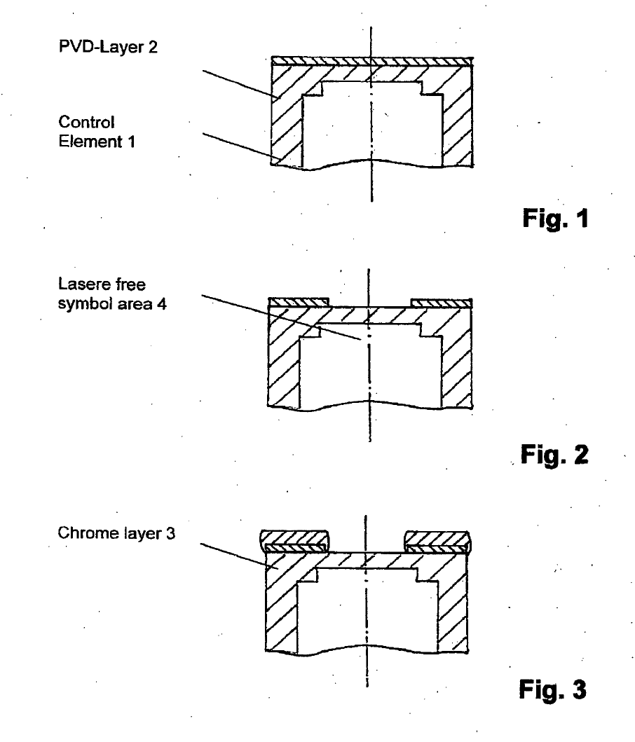

FIG. 1 illustrates a metallized plastic component 1 that includes a first coupling metallic layer, such as a PVD layer 2 and a second metallic covering layer 3 that can be deposited wet chemically on the coupling layer. Referring to FIG. 2, it can be seen that areas in the coupling layer are removed by a laser so that a display region 4 is introduced into the coupling layer and the covering layer 3 is applied only in the area of the coupling layer 2. In an alternative embodiment, the covering layer 3, for example, a chrome layer, can completely cover the PVD layer 2, however, in this case, the chrome layer 3 should have a thickness that still enables the display region 4 to be visible. Further, the plastic component 1 can be translucent when lighted. Also, the display region 4 can be reflective.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A metallized plastic component comprising:
a first coupling metallic layer; and
a second metallic covering layer deposited wet chemically on the coupling layer,
wherein areas in the coupling layer are removed by a laser so that a display region is introduced into the coupling layer and the covering layer is applied only in the area of the coupling layer.

2. The component according to claim 1, wherein the plastic component is made of polycarbonate (PC), acrylonitrile-butadiene-styrene (ABS), (PC+ABS) blends, polyamide (PA), or polymethyl methacrylate (PMMA).

3. The component according to claim 1, wherein the coupling layer has a thickness of 200 nm to 500 nm, particularly about 300 nm, and is made of one or more of the elements: copper, nickel, molybdenum, chromium, or aluminum.

4. The component according to claim 1, wherein the covering layer has a thickness of 20 μm to 100 μm, preferably a thickness of 30 μm to 60 μm.

5. The component according to claim 1, wherein the plastic component is a backlit control element for a motor vehicle and wherein the plastic component, in the display area, has a thickness of about 0.6 mm.

6. The component according to claim 1, wherein a clear or colored coating layer is applied to the covering layer.

7. A method for the manufacture of a metallized plastic component according to 1 the method comprising:
applying first a coupling metallic layer to the plastic component by a PVD process; and
secondly, applying a metallic covering layer to the coupling layer by wet chemical deposition,
wherein, before the application of the covering layer, the coupling layer is removed in areas by a laser, and
wherein the covering layer is applied only in the area of the remaining coupling layer.

8. The method according to claim 7, wherein the coupling layer is applied in a thickness of 200 nm to 500 nm and is made of one or more of the elements: copper, nickel, molybdenum, chromium or aluminum.

9. The method according to claim 7, wherein the covering layer is applied by electrolytic metallization and in a thickness of 20 μm to 100 μm.

10. The method according to claim 9, wherein a chromium layer is applied by electrolytic metallization.

11. The method according to claim 7, wherein a clear or colored coating layer is applied to the covering layer.
